(19) United States
(12) Patent Application Publication
(10) Pub. No.: US 2020/0170089 A1
(43) Pub. Date: May 28, 2020

(54) POWER SUPPLY SYSTEM FOR A LIGHTING SYSTEM

(71) Applicant: MAC SRL CON UNICO SOCIO, Recanati (IT)

(72) Inventor: Luigi Mandolini, Recanati (IT)

(73) Assignee: MAC SRL CON UNICO SOCIO, Recanati (IT)

(21) Appl. No.: 16/627,639

(22) PCT Filed: Jun. 29, 2018
(86) PCT No.: PCT/IB2018/054859

§ 371 Date: Dec. 30, 2019

(30) Foreign Application Priority Data
Jun. 29, 2017 (IT) 102017000073066

(51) Int. Cl. H05B 45/382; H05B 47/18; H05B 45/325; H05B 45/355

(52) U.S. Cl. CPC H05B 45/382; H05B 45/355; H05B 45/325; H05B 47/18

(57) ABSTRACT

Power supply system for a lighting system comprising a plurality of LED light points, the power supply system having AC/DC voltage converter means to convert an AC voltage into a first DC voltage, one or more DC/DC voltage converter means connected to the output of the AC/DC voltage converter means and having current- and/or voltage-driven output ports connectable to respective light points, a plurality of input ports and a programmable microcontroller to associate each input port to at least one of said output ports and configured to control the DC/DC voltage converter means so as to switch on and off or to adjust the light intensity of said light points based on the commands received by the input ports.

### PRIORITY CLAIM

This application claims priority from Italian Patent Application No. 102017000073066 filed on 29 Jun. 2017, the disclosure of which is incorporated by reference.

### TECHNICAL FIELD

The present invention relates to a power supply system for a lighting system.

In particular, the present invention finds advantageous, but not exclusive, application in a lighting system comprising a large number of LED light points whose switching on and off and/or adjustment of light intensity must be controlled, to which the following description will make explicit reference without thereby losing its general character.

### BACKGROUND ART

Typically, a LED lighting system including many light points, whose switching on and off and/or adjustment of light intensity must be controlled, requires a large number of power supplies. The required number of power supplies increases by increasing the types of controls on light points, such as e.g. an automatic control based on ambient brightness or a remote control. The power supplies required by a LED lighting system often have different output powers. Low power supplies have a low energy efficiency, typically comprised between 75% and 80%.

The increase in the number of electrical or electronic devices to be located in the rooms necessarily entails some drawbacks. For example, power supplies are bulky and aesthetically unpleasant devices and it is therefore necessary to find spaces to conceal them. Each device must be powered, and therefore must be reached by relative power cables that complicate the wiring of the lighting system. If the lighting system includes a device control system, then each device must also be reached by relative control cables. Moreover, each device produces electromagnetic pollution and consumes electric power even when it is on stand-by. Finally, the inclusion of new devices in an existing lighting system could give compatibility problems.

### DISCLOSURE OF INVENTION

The object of the present invention is to provide a power supply system for a LED lighting system, which is free from the aforesaid drawbacks and, at the same time, is easy and inexpensive to manufacture.

According to the present invention, it is provided a power supply system for a lighting system comprising a plurality of light points, as defined in the appended claims.

### BRIEF DESCRIPTION OF THE DRAWINGS

The present invention will be now described with reference to the accompanying drawings showing a non-limiting embodiment, in which:

FIG. 1 shows a block diagram of the power supply system made according to the dictates of the present invention; and

FIG. 2 shows in more detail a part of the power supply system of FIG. 1.

### BEST MODE FOR CARRYING OUT THE INVENTION

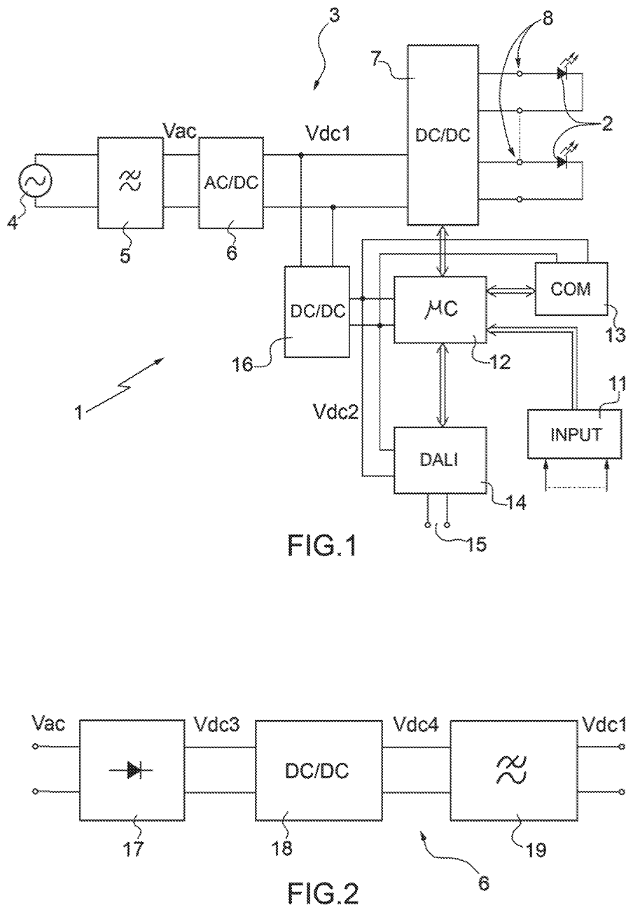

In FIG. 1, the reference number 1 generically indicates, as a whole, a lighting system, which comprises a plurality of LED light points 2 and a power supply system 3 connected to the AC power network 4 and adapted to electrically power the light points 2.

The power supply system 3 comprises an input filter 5 to block high frequency electromagnetic disturbances originating from the power network 4 and emitted by the power supply system 3, and AC/DC voltage converter means 6 of a known type connected to the output of the input filter 5 to convert the AC voltage Vac supplied by the power network 4 into a first DC voltage Vdc1.

The power supply system 3 comprises one or more DC/DC voltage converter means 7 connected to the output of the AC/DC voltage converter 6 and having as a whole a plurality of current- and/or voltage-driven output ports 8, electrically connectable to respective light points 2 so that each outlet port 8 can electrically feed a respective light point 2.

Moreover, the power supply system 3 comprises an input device 11 having a plurality of input ports, each of which can be associated to a respective output port 8, and a microcontroller 12, which is programmable to associate the ports of the input device 11 to the output ports 8 and is configured to control DC/DC voltage converter means 7 so as to control output ports 8 to switch on and off or to adjust the light intensity of the light points 2 based on the commands received by the input ports 11. The ports of the input device 11 are connectable to low voltage buttons or to switches having so-called clean contacts.

The programmability of the associations between the ports of the input device 11 and the output ports 8 is free, so that a single port of the input device 11 may be associated to a single output port 8 and/or a single port of the input device 11 may be associated to a plurality of output ports 8 or to all output ports 8, e.g. to set the light intensity to a certain level simultaneously on several output ports 8 or to set the light intensity to different levels for different groups of output ports 8.

The power supply system 3 comprises a communication module 13, which e.g. consists of a radio communication module, e.g. a WiFi module, or a Bluetooth module, or a Zigbee module, or a wired communication module, e.g. an Ethernet network module, or a serial communication module of the RS232 type, and is interfaced with the microcontroller 12, and a DALI port 14, which is provided with a respective DALI bus 15 and is also interfaced with the microcontroller 12. The communication module 13 allows programming the association between the ports of the input device 11 and the output ports 8 in the microcontroller 12 via mobile communication devices (not shown), such as a tablet PC or a smartphone, configured with special applications (App) designed to work in different operating systems, such as iOS, Android and Windows Phone.

When the communication module 13 is constituted by a wired communication module, the association between the ports of the input device 11 and the output ports 8 can be programmed via a PC.

The communication module 13 enables a direct driving of the output ports 8 by means of a mobile communication device (not shown), e.g. a tablet PC or a smartphone, configured with a specific application (App) designed to work in different operating systems for mobile communication devices, such as e.g. iOS, Android and Windows Phone.

The DALI port 14 allows controlling and driving the output ports 8 through home automation devices using the DALI communication protocol.

The communication module 13 and the DALI port 14 also allow programming by means of mobile communication devices and, respectively, by means of DALI home automation devices, the driving mode of the output ports 8, selectable between voltage and current driving, the level of maximum power that can be supplied by the output ports 8 and the adjustment mode of the power that can be supplied by the output ports 8, which is selectable among analogue mode, PWM (Pulse Width Modulation) mode and mixed analogue-PWM mode. The adjustment of the output power 8 allows adjusting the light intensity of the light point 2 connected to said output port 8.

The microcontroller 12 is preconfigured with a default association between ports of the input device 11 and output ports 8. In this way, the power supply system 3 can be used in a “Plug & Play” mode, namely it can operate without necessarily having to program the association between input ports and output ports.

Finally, the power supply system 3 comprises a high efficiency DC/DC power supply unit 16 connected to the output of the AC/DC voltage converter means 6 to convert the voltage Vdc1 into a second DC voltage Vdc2 having a voltage suitable for electrically powering the microcontroller 12, the communication module 13 and the DALI port 14.

With reference to FIG. 2, the AC/DC voltage converter 6 comprises, in cascade, in the following order: a voltage rectifier stage 17 provided with a power factor corrector to transform the Vac voltage into a DC voltage Vdc3; a DC/DC voltage converter stage 18 of the type having a galvanic isolation between input and output to transform the voltage Vdc3 into a further DC voltage, indicated as Vdc4; and a low-pass filter 19 to filter the disturbances originating from the power network and to eliminate the emission of electromagnetic disturbances, so that the voltage Vdc1 thus obtained is suitable for supplying the DC/DC voltage converter means 7 and the DC/DC supply unit 16. In particular, the DC/DC voltage converter means 18 consist of a half-bridge resonant converter of known type. In use, the power supply system 3 can be used both with switches connected to the ports of the input device 11 and with low voltage switches connected in series to the light points 2 directly on the output ports 8. In the first case, it is possible to exploit the pre-configuration of the microcontroller 12 between ports of the input device 11 and output ports 8 or to reprogram the association between ports of the input device 11 and output ports 8 with commands acquired via the communication module 13 or the DALI port 14. In the latter case, the input device 11 is in fact excluded and the wiring is optimized.

The power supply system 3 is obviously suitable for controlling light points 2 generally operating at low voltage, even different from LEDs.

The main advantage of the power supply system 3 described above is to be a single device for powering and programming all the light points 2 of a lighting system 1. Through a mobile communication device in the hands of a user, the communication module 13 allows programming the configuration of the output ports 8 to define the current or voltage output and establish the maximum power that can be supplied. The DALI port 14 allows programming the configuration of the output ports 8 to define the current or voltage output and establish the maximum power that can be supplied by means of home automation devices using the DALI communication protocol.

Moreover, the power supply system 3 comprises a single AC/DC power supply unit 6 which, having to supply the entire lighting system 1, must have a high output power and therefore can achieve a high energy efficiency, typically higher than the 90%, which is higher than that of a plurality of small power supplies distributed in the plant.

1. A power supply system for a lighting system comprising a plurality of light points, in particular LED light points, the power supply system comprising AC/DC voltage converter means to convert an AC voltage into a first DC voltage, and first DC/DC voltage converter means, which are connected to the output of said AC/DC voltage converter means and have output ports, which are current- and/or voltage-driven and are electrically connectable to relative light points of the lighting system; the power supply system being characterized in that it comprises a plurality of input ports and control means, which are programmable to associate each input port to at least one of said output ports, and are configured to control said first DC/DC voltage converter means so as to switch on and off or to adjust the light intensity of said light points based on the commands received by the input ports.

2. A power supply system according to claim 1 and comprising communication means, which are interfaced with said control means and configured to allow programming the association between said input ports and said output ports.

3. A power supply system according to claim 1 and comprising communication means, which are interfaced with said control means to allow programming the driving mode of said output ports, selectable between voltage and current driving, the level of maximum power suppliable by the output ports and the adjustment mode of the power suppliable by said output ports, selectable among analogue mode, PWM mode and mixed analogue-PWM mode.

4. A power supply system according to claim 1 and comprising communication means interfaced with said control means to enable a direct driving of the output ports by means of a mobile communication device or a DALI home automation device.

5. A power supply system according to claim 1, wherein said control means are pre-configured with a default association between said input ports and said output ports.

6. A power supply system according to claim 1 and comprising a DC/DC power supply unit, which is connected to the output of said AC/DC voltage converter means to transform said first DC voltage into a second DC voltage having a voltage that is suited to electrically power said control means.

7. A power supply system according to claim 1, wherein said AC/DC voltage converter means comprise a rectifier stage to transform said AC voltage into a third DC voltage, and second DC/DC voltage converter means of the type having a galvanic isolation between input and output, so as to convert the third DC voltage into a fourth DC voltage.

8. A power supply system according to claim 7, wherein said AC/DC voltage converter means comprise a low-pass filter, which is connected to the output of said second DC/DC voltage converter means so as to reduce electromagnetic disturbance and to provide said first DC voltage.

9. A power supply system according to claim 7, wherein said second DC/DC voltage converter means comprise a power factor corrector.

10. A power supply system according to claim 2 and comprising communication means, which are interfaced with said control means to allow programming the driving mode of said output ports, selectable between voltage and current driving, the level of maximum power suppliable by the output ports and the adjustment mode of the power suppliable by said output ports, selectable among analogue mode, PWM mode and mixed analogue-PWM mode.

11. A power supply system according to claim 2 and comprising communication means interfaced with said control means to enable a direct driving of the output ports by means of a mobile communication device or a DALI home automation device.

12. A power supply system according to claim 3 and comprising communication means interfaced with said control means to enable a direct driving of the output ports by means of a mobile communication device or a DALI home automation device.

13. A power supply system according to claim 2, wherein said control means are pre-configured with a default association between said input ports and said output ports.

14. A power supply system according to claim 3, wherein said control means are pre-configured with a default association between said input ports and said output ports.

15. A power supply system according to claim 4, wherein said control means are pre-configured with a default association between said input ports and said output ports.

16. A power supply system according to claim 2 and comprising a DC/DC power supply unit, which is connected to the output of said AC/DC voltage converter means to transform said first DC voltage into a second DC voltage having a voltage that is suited to electrically power said control means.

17. A power supply system according to claim 3 and comprising a DC/DC power supply unit, which is connected to the output of said AC/DC voltage converter means to transform said first DC voltage into a second DC voltage having a voltage that is suited to electrically power said control means.

18. A power supply system according to claim 4 and comprising a DC/DC power supply unit, which is connected to the output of said AC/DC voltage converter means to transform said first DC voltage into a second DC voltage having a voltage that is suited to electrically power said control means.

19. A power supply system according to claim 5 and comprising a DC/DC power supply unit, which is connected to the output of said AC/DC voltage converter means to transform said first DC voltage into a second DC voltage having a voltage that is suited to electrically power said control means.

20. A power supply system according to claim 2, wherein said AC/DC voltage converter means comprise a rectifier stage to transform said AC voltage into a third DC voltage, and second DC/DC voltage converter means of the type having a galvanic isolation between input and output, so as to convert the third DC voltage into a fourth DC voltage.
